(19) United States
(12) Patent Application Publication
(10) Pub. No.: US 2010/0232875 A1
(43) Pub. Date: Sep. 16, 2010

(54) MECHANICAL COUPLING

(76) Inventors: James Cunningham, Lincoln (GB); Adrian Theodorus Sanders, Newark (GB); AC Mackenzie, Newark (GB); Andrew Shepherd, Branston (GB)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/529,768

(22) PCT Filed: Feb. 29, 2008
(86) PCT No.: PCT/EP2008/052509

§ 371 Date: Apr. 7, 2010

(30) Foreign Application Priority Data
Mar. 5, 2007 (GB) 0704155.1

(51) Int. Cl. F16D 1/02; B24C 1/00

(52) U.S. Cl. 403/364; 451/36

(57) ABSTRACT

A mechanical coupling for transferring torque from a first component that rotates about an axis to a second component that also rotates about the axis is provided. The coupling allows different rates of expansion of the first and second components in the radial direction by permitting sliding in the radial direction of the components relative to one another. The coupling comprises first and second circular arrays of teeth formed on the first component and second component, respectively, and centered on the axis. The first circular array of teeth are intermeshed with the second circular array of teeth, wherein rotation of the first component causes first mating sides on the first circular array of teeth to bear against second mating sides on the second circular array of teeth transferring torque to the second component. The first and second mating sides extend both axially and radially and are essentially curved.

### CROSS REFERENCE TO RELATED APPLICATIONS

This application is the US National Stage of International Application No. PCT/EP2008/052509, filed Feb. 29, 2008 and claims the benefit thereof. The International Application claims the benefits of Great Britain application No. 0704155.1 GB filed Mar. 5, 2007, both of the applications are incorporated by reference herein in their entirety.

### FIELD OF INVENTION

The present invention relates to a mechanical coupling.

More particularly the present invention relates to a mechanical coupling for transferring torque from a first component that rotates about an axis to a second component that also rotates about the axis, the coupling allowing different rates of expansion of the first and second components in the radial direction by permitting sliding in the radial direction of the first and second components relative to one another, the coupling comprising: a first circular array of teeth formed on the first component and centred on the axis; and a second circular array of teeth formed on the second component and also centred on the axis, the first circular array of teeth being intermeshed with the second circular array of teeth, wherein rotation of the first component causes first mating sides on the first circular array of teeth to bear against second mating sides on the second circular array of teeth thereby to transfer torque to the second component.

### BACKGROUND OF INVENTION

It is known to use such a mechanical coupling in a gas turbine engine. FIG. 1 is a longitudinal cross section through a part of a gas turbine engine. In this engine, a first such coupling 1 is used between the rotor shaft 3 and a first turbine disc 5, and a second such coupling 7 is used between the first turbine disc 5 and a second turbine disc 9. The couplings 1, 7 allow different rates of radial expansion of the rotor shaft 3, and first and second turbines discs 5, 9. To not allow this would result in high stresses in the components.

It has been found with the engine of FIG. 1 that, once it reaches a certain speed, high vibration occurs suddenly.

### SUMMARY OF INVENTION

According to the present invention there is provided a mechanical coupling for transferring torque from a first component that rotates about an axis to a second component that also rotates about the axis, the coupling allowing different rates of expansion of the first and second components in the radial direction by permitting sliding in the radial direction of the first and second components relative to one another, the coupling comprising: a first circular array of teeth foamed on the first component and centred on the axis; and a second circular array of teeth formed on the second component and also centred on the axis, the first circular array of teeth being intermeshed with the second circular array of teeth, wherein rotation of the first component causes first mating sides on the first circular array of teeth to bear against second mating sides on the second circular array of teeth thereby to transfer torque to the second component, wherein the first and second mating sides extend both axially and radially, and the first and/or second mating sides are to some degree curved in both the axial and radial directions so that the pressure between the sides when mated is more uniformly distributed over the sides.

In a mechanical coupling according to the preceding paragraph, it is preferable that a part of the periphery of the first and/or second mating sides is curved.

In a mechanical coupling according to the preceding paragraph, it is preferable that the curvature of the part is substantially tangential to the remainder of the first/second mating side where it meets the remainder.

In a mechanical coupling according to either of the preceding two paragraphs, it is preferable that the first and second mating sides are substantially rectangular in shape with one of the four sides of the rectangle meeting the first/second component, the remaining three sides of the rectangle constituting the part of the periphery that is curved.

In a mechanical coupling according to any one of the preceding four paragraphs, it is preferable that the first and/or second mating sides are bowed in form.

In a mechanical coupling according to the preceding paragraph and any one of the three paragraphs but one preceding that paragraph, it is preferable that the first and second mating sides are substantially rectangular in shape with one of the four sides of the rectangle meeting the first/second component, and the bowing is (i) in a first direction substantially parallel to one pair of opposite sides of the rectangle, and/or (ii) in a second direction substantially parallel to the other pair of opposite sides of the rectangle.

In a mechanical coupling according to the preceding paragraph but one and the paragraph preceding that paragraph, it is preferable that the bowing is (i) in a first direction substantially parallel to one pair of opposite sides of the rectangle, and/or (ii) in a second direction substantially parallel to the other pair of opposite sides of the rectangle.

The present invention also provides a gas turbine engine including a mechanical coupling according to any one of the preceding seven paragraphs.

The present invention further provides a method of making a mechanical coupling according to any one of the preceding seven paragraphs but one wherein in the formation of the first and/or second mating sides an abrasive fluid is passed over the sides.

### BRIEF DESCRIPTION OF THE DRAWINGS

The invention will now be described, by way of example, with reference to the accompanying drawings, in which:

FIG. 1, already referred to, is a longitudinal cross section through a part of a gas turbine engine;

FIG. 2 is a schematic diagram of a mechanical coupling;

FIG. 3 is a cross section on the line III-III in FIG. 2;

FIG. 4 is a view in the direction of arrow IV in FIG. 3;

FIG. 5 illustrates operation of the coupling;

FIG. 6 shows the interface VI-VI in FIG. 5;

FIG. 7 is a cross section on the line VII-VII in FIG. 5;

FIG. 8 illustrates a modification to the coupling, which modification is according to the present invention;

FIG. 9 shows the interface IX-IX in FIG. 8;

FIG. 10 is a cross section on the line X-X in FIG. 8;

FIG. 11 illustrates a further modification to the coupling, which further modification is also according to the present invention; and

FIG. 12 is a cross section on the line XII-XII in FIG. 11.

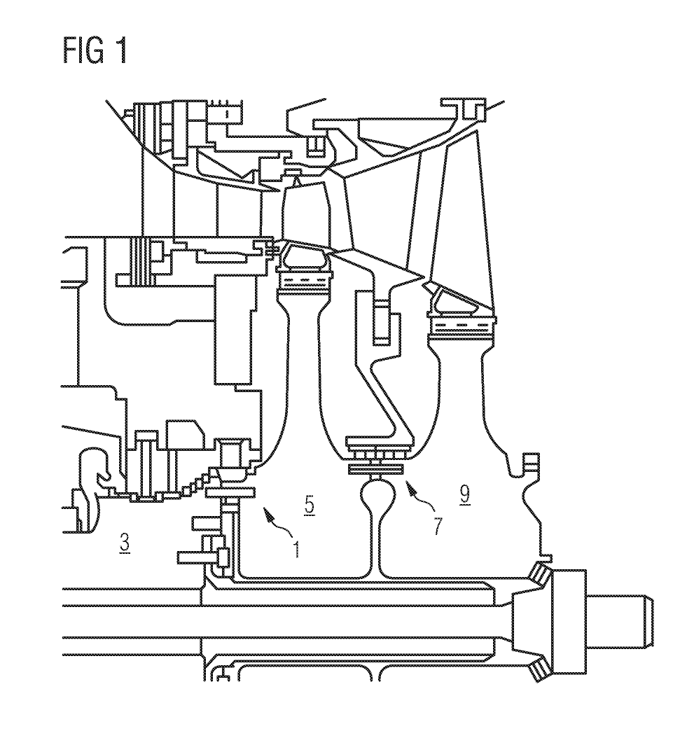

### DETAILED DESCRIPTION OF INVENTION

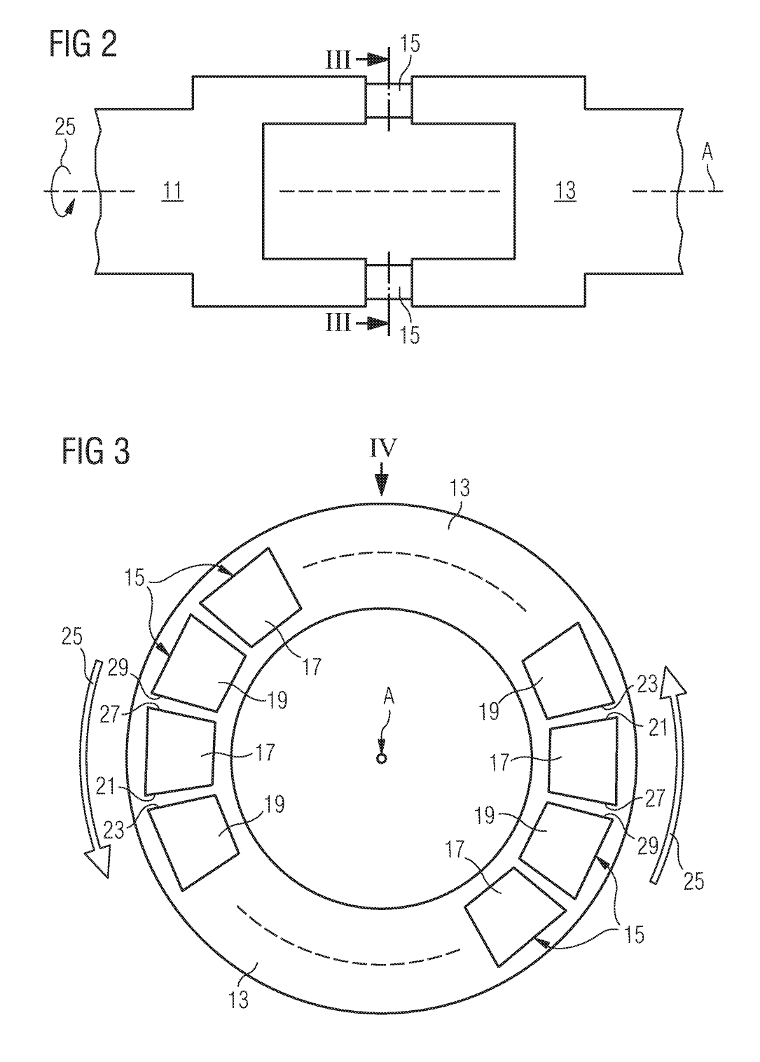

Referring to FIG. 2, a first component 11 is coupled to a second component 13 by means of a mechanical coupling 15. First and second components 11, 13 are both mounted for rotation about an axis A. First component 11 is driven, and coupling 15 operates to transfer torque from the first component to passive second component 13 so that component 13 is also driven to rotate about axis A.

Referring to FIG. 3, coupling 15 comprises a first circular array of teeth 17 formed on first component 11, and a second circular array of teeth 19 formed on second component 13. Both circular arrays 17, 19 are centred on axis A, and the arrays are intermeshed as shown in FIG. 3 such that first mating sides 21 of first circular array 17 are disposed in circumferential opposed relation to second mating sides 23 of second circular array 19. Rotation of the first component 11 about axis A in the direction of arrows 25, see also FIG. 2, causes the first mating sides 21 to bear against the second mating sides 23 thereby also to rotate the second component 13 about axis A in the direction of arrows 25. All circumferentially opposed sides 21, 23, 27, 29 of the teeth of arrays 17, 19 extend radially with respect to axis A thereby allowing different rates of radial expansion of components 11, 13 by permitting radial sliding of the components relative to one another.

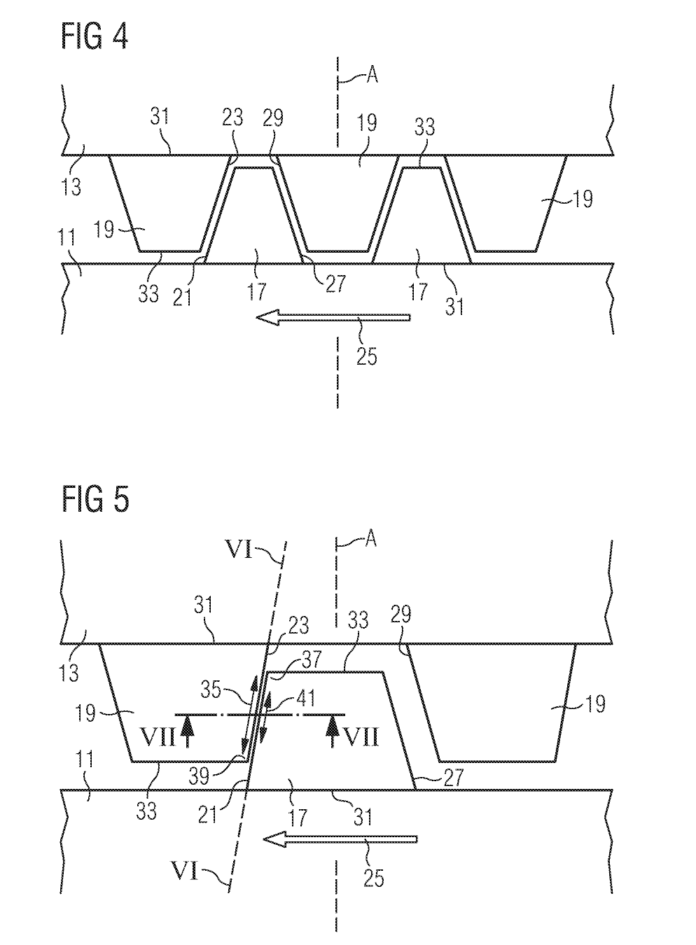

Referring to FIG. 4, each tooth of arrays 17, 19 tapers in the axial direction from a broad base 31 proximate first/second component 11, 13 to a relatively narrow blunt tip 33 remote from first/second component 11, 13.

Referring to FIG. 5, rotation of first component 11 about axis A in the direction of arrow 25 causes each first mating side 21 to bear against a corresponding second mating side 23.

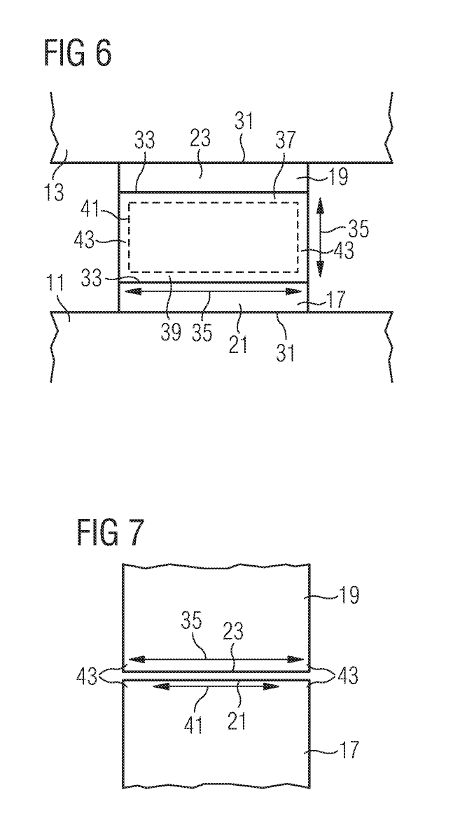

Referring also to FIGS. 6 and 7, each pair of mating sides 21, 23 contact one another in an area of overlap 35. The pressure between the mating sides in this area is locally high at the edges 37, 39, 43 of teeth 17, 19, and low in the region 41 inside edges 37, 39, 43.

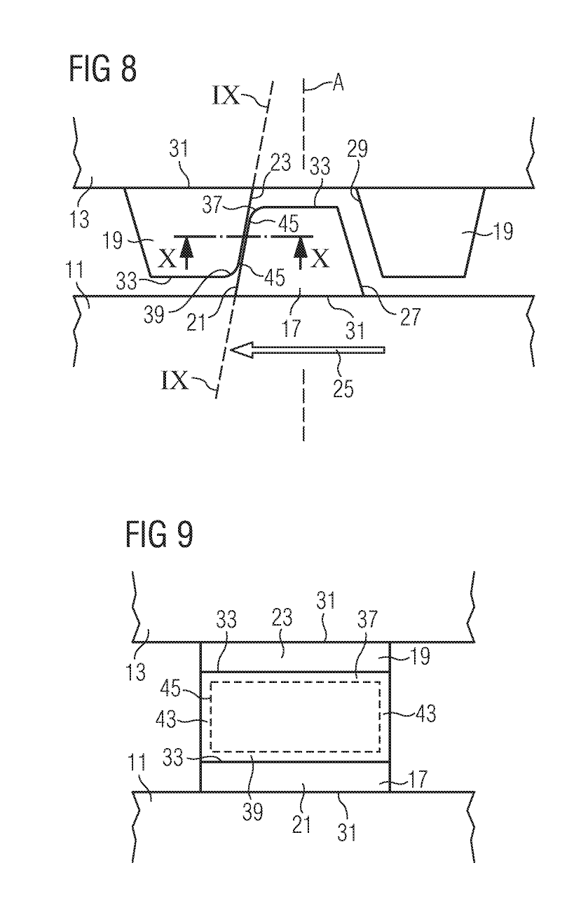

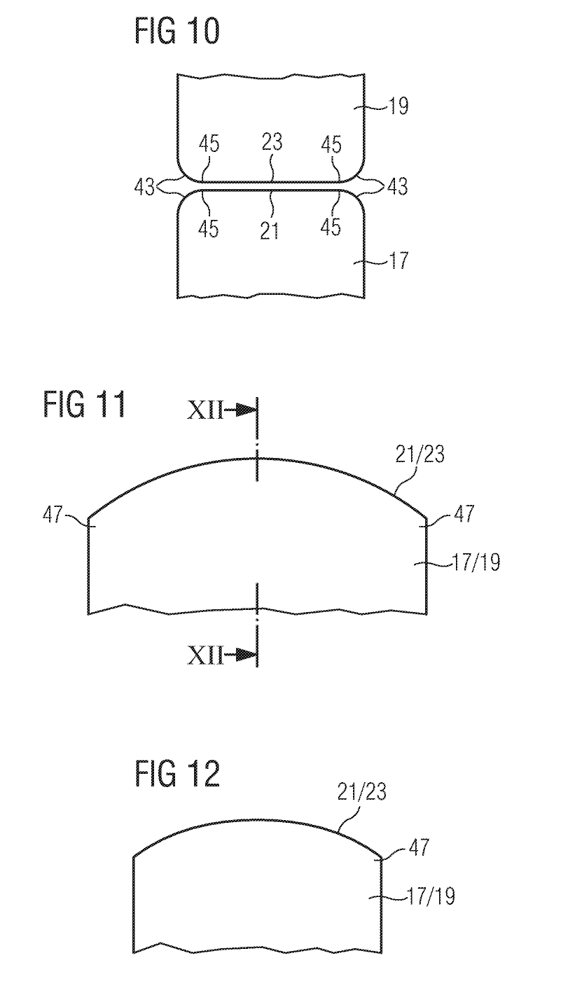

Referring to FIGS. 8 to 10, in accordance with the present invention, the coupling is modified by curving edges 37, 39, 43 so that the pressure between the mating sides 21, 23 is more uniformly distributed over the sides, i.e. the curving smoothes edges 37, 39, 43 so that the pressure at these edges is no longer locally high. The curved edges 37, 39, 43 are tangential to the remainder of the first/second mating side where they meet this remainder—this meeting is referenced 45 in FIGS. 8 to 10. The curving of the edges is of benefit as will now be explained in the context of use of the coupling in a gas turbine engine.

The first and second components 11, 13 will not slide relative to one another in the radially outward direction until the friction between mating sides 21, 23 is overcome. Provided this friction is overcome at the same time at all positions around the circular arrays of teeth 17, 19 then eccentricity of the components 11, 13 with respect to axis A will not occur, and there will be no imbalance in the rotation of the components about the axis.

In a gas turbine engine as the speed of the engine increases there is an increase in both the temperature of, and pressure between, mating sides 21, 23. It has been found that, whereas at relatively low temperatures and pressures the coefficient of friction between the mating sides is relatively low, upon both the temperature and pressure reaching a relatively high level the coefficient increases significantly. If the temperature or pressure remains relatively low, then the coefficient does not increase significantly. For the increase to occur both the temperature and pressure must reach high levels. This significant increase in the coefficient of friction between mating sides 21, 23 increases the susceptibility of the coupling to producing eccentricity about axis A.

The curving of edges 37, 39, 43, as described with reference to FIGS. 8 to 10, removes the areas of locally high pressure between mating sides 21, 23, thereby ensuring that the pressure between the sides never reaches a level at which the coefficient of friction between the sides increases significantly. In the prior art, absent the curving of edges 37, 39, 43, at a certain speed of rotation of components 11, 13 the temperature and pressure reach levels at which the coefficient of friction increases significantly. This results in the circular arrays of teeth 17, 19 sliding relative to one another in the radially outward direction in a manner that is not uniform around their circular than. This gives rise to eccentricity about axis A, producing imbalance and consequent vibration in the engine.

Referring to FIGS. 11 and 12, in the further modification according to the present invention, the curving to remove areas of locally high pressure occurs over the full extent of mating sides 21, 23, i.e. is not restricted to the edges 37, 39, 43 whereat there are areas of locally high pressure. The sides 21, 23 are bowed in both the radial direction, FIG. 11, and the axial direction, FIG. 12. An advantage of the bowing is that if a pair of mating sides 21, 23 are slightly askew relative to one another due to manufacturing variation in the teeth 17, 19, this askew relationship is to some extent compensated for by the bowing—the bowing helps prevent areas of locally high pressure between the mating sides that would otherwise occur due to the askew relationship.

Circular arrays of teeth 17, 19 having mating sides as described with reference to FIGS. 8 to 12 may be made by a method wherein the sides are finished by passing an abrasive fluid over the sides. The circular array the mating sides of which are to be finished is placed in a fixture that leaves a small gap between itself and the mating sides. An abrasive fluid, a jelly containing abrasive chips, is forced under pressure through the gap. The application of the abrasive fluid is controlled so as to form the required profile on the mating sides. Finishing the mating sides using an abrasive fluid solves a problem encountered with the prior art method of finishing, as will now be explained.

In the prior art the mating sides are finished using a grinding wheel. This gives rise to formation of slight ridges in the form of waves on the mating sides. These waves cross one another when the mating sides mate, with the result that undesirable areas of locally high pressure occur at the points where the waves cross. Further, the ridges at these points may yield resulting in interlock between the ridges preventing the mating sides sliding over one another. Finishing of the mating sides using an abrasive fluid greatly reduces the height of the ridges on the sides.

In FIGS. 8 to 10 curved edges 37, 39, 43 are tangential to the remainder of the first/second mating side 21, 23 where they meet, at 45, this remainder. It is to be realised that this meeting could be non-tangential and still provide a significant reduction in the locally high pressure at edges 37, 39, 43.

It is to be realised that the curving of edges 37, 39, 43, as described with reference to FIGS. 8 to 10, could be used in combination with the bowing of mating sides 21, 23, as described with reference to FIGS. 11 and 12, i.e. the edges of bowed mating sides 21, 23 corresponding to edges 37, 39, 43 could be curved, see the corresponding edges 47 in FIGS. 11 and 12.

1.-9. (canceled)

10. A mechanical coupling for a gas turbine engine for transferring a torque from a first component of the gas turbine engine that rotates about an axis to a second component of the gas turbine engine that also rotates about the axis, the coupling comprising:
a first circular array of teeth formed on the first component and centered on the axis; and
a second circular array of teeth formed on the second component and also centered on the axis,
wherein the mechanical coupling allows different rates of expansion of the first component and the second component in the radial direction by permitting sliding in the radial direction of the first component and the second component relative to one another,
wherein the first circular array of teeth are intermeshed with the second circular array of teeth,
wherein a rotation of the first component causes a plurality of first mating sides on the first circular array of teeth to bear against a plurality of second mating sides on the second circular array of teeth thereby transferring the torque to the second component,
wherein the plurality of first mating sides and the plurality of second mating sides extend in both an axial direction and a radial direction, and
wherein the plurality of first mating sides and/or the plurality of second mating sides are to some degree curved in both the axial direction and the radial direction so that a pressure between the sides when mated is more uniformly distributed over the sides ensuring that the pressure between the sides stays below a level at which a coefficient of friction between the sides increases significantly.

11. The mechanical coupling as claimed in claim 10, wherein a part of a periphery of each first mating side and/or each second mating side is curved.

12. The mechanical coupling as claimed in claim 11, wherein the curvature of the part is substantially tangential to a remainder of each first and/or second mating side where it meets the remainder.

13. The mechanical coupling as claimed in claim 12, wherein each first and second mating side is substantially rectangular in shape with one of the four sides of the rectangle meeting the first and/or second component, the remaining three sides of the rectangle constituting the part of the periphery that is curved.

14. The mechanical coupling as claimed in claim 13, wherein the plurality of the first mating sides and/or the plurality of second mating sides are bowed in form.

15. The mechanical coupling as claimed in claim 14,
wherein the plurality of first and second mating sides are substantially rectangular in shape with one of the four sides of the rectangle meeting the first/second component, and
wherein the bowing is in a first direction substantially parallel to one pair of opposite sides of the rectangle, and/or in a second direction substantially parallel to the other pair of opposite sides of the rectangle.

16. The mechanical coupling as claimed in claim 14, wherein the bowing is in a first direction substantially parallel to one pair of opposite sides of the rectangle and/or in a second direction substantially parallel to the other pair of opposite sides of the rectangle.

17. The mechanical coupling as claimed in claim 10, wherein each tooth in the first circular array of teeth and the second circular array of teeth tapers in the axial direction from a broad base adjacent to the first component and/or the second component to a more narrow blunt tip on an opposite side of the first and/or second component, respectively.

18. A gas turbine engine, comprising:
a mechanical coupling, comprising:
a first circular array of teeth formed on the first component and centered on the axis, and
a second circular array of teeth formed on the second component and also centered on the axis,
wherein the mechanical coupling allows different rates of expansion of the first component and the second component in the radial direction by permitting sliding in the radial direction of the first component and the second component relative to one another,
wherein the first circular array of teeth are intermeshed with the second circular array of teeth,
wherein a rotation of the first component causes a plurality of first mating sides on the first circular array of teeth to bear against a plurality of second mating sides on the second circular array of teeth thereby transferring the torque to the second component,
wherein the plurality of first mating sides and the plurality of second mating sides extend in both an axial direction and a radial direction, and
wherein the plurality of first mating sides and/or the plurality of second mating sides are to some degree curved in both the axial direction and the radial direction so that a pressure between the sides when mated is more uniformly distributed over the sides ensuring that the pressure between the sides stays below a level at which a coefficient of friction between the sides increases significantly.

19. The gas turbine as claimed in claim 18, wherein a part of a periphery of each first mating side and/or each second mating side is curved.

20. The gas turbine as claimed in claim 19, wherein the curvature of the part is substantially tangential to a remainder of each first and/or second mating side where it meets the remainder.

21. The gas turbine as claimed in claim 20, wherein each first and second mating side is substantially rectangular in shape with one of the four sides of the rectangle meeting the first and/or second component, the remaining three sides of the rectangle constituting the part of the periphery that is curved.

22. The gas turbine as claimed in claim 21, wherein the plurality of the first mating sides and/or the plurality of second mating sides are bowed in form.

23. The gas turbine as claimed in claim 22,
wherein the plurality of first and second mating sides are substantially rectangular in shape with one of the four sides of the rectangle meeting the first/second component, and
wherein the bowing is in a first direction substantially parallel to one pair of opposite sides of the rectangle, and/or in a second direction substantially parallel to the other pair of opposite sides of the rectangle.

24. The gas turbine as claimed in claim 22, wherein the bowing is in a first direction substantially parallel to one pair of opposite sides of the rectangle and/or in a second direction substantially parallel to the other pair of opposite sides of the rectangle.

25. The gas turbine as claimed in claim 18, wherein each tooth in the first circular array of teeth and the second circular array of teeth tapers in the axial direction from a broad base adjacent to the first component and/or the second component to a more narrow blunt tip on an opposite side of the first and/or second component, respectively.

26. A method of making a mechanical coupling for a gas turbine engine, comprising:
passing an abrasive fluid over a plurality of first mating sides and/or a plurality of second mating sides in a formation of the first and/or second mating sides; and
controlling an application of the abrasive fluid forming a required profile on the plurality of first and second mating sides with a reduced height of ridges on the plurality of first and second mating sides,
wherein when the mechanical coupling is used, a pressure between the plurality of first and second mating sides when mated is more uniformly distributed over the sides ensuring that the pressure between the sides stays below a level at which a coefficient of friction between the sides increases significantly.

27. A method of making a mechanical coupling for a gas turbine engine as claimed in claim 26, wherein the abrasive fluid is a jelly containing a plurality of abrasive chips.
